(19) United States
(12) Patent Application Publication
(10) Pub. No.: US 2005/0276043 A1
(43) Pub. Date: Dec. 15, 2005

(54) Support for the fluorescent light

(76) Inventors: Jianxiong He, Foshan City (CN); Jianbo Wen, Foshan City (CN)

Correspondence Address: COOPER & DUNHAM, LLP, 1185 AVENUE OF THE AMERICAS, NEW YORK, NY, 10036, US

(21) Appl. No.: 11/140,509

(22) Filed: May 26, 2005

Related U.S. Application Data
(63) Continuation of application No. PCT/CN03/00907, filed on Oct. 28, 2003.

(30) Foreign Application Priority Data
Nov. 26, 2002 (CN) 02152060.7

(51) Int. Cl. F21V 7/00

(52) U.S. Cl. 362/225; 362/223; 362/346

(57) ABSTRACT

An improved support for the fluorescent light includes a house, a “reflector, a frame for fixing the reflector, fluorescent lamps, a transparent plate, a waterproof washer, which is characterized that the reflector is formed into the shape of open pentagonal prism or open hexagonal prism. According to the present invention, the flux in front of the fluorescent lamp can be increased obviously by the plural reflecting surface of the reflector when the light source is located in a special position ahead of the reflector, thereby saving power.

### FIELD OF THE INVENTION

The present invention relates a support for the fluorescent light or, particularly, a support for the fluorescent light for lighting.

### BACKGROUND OF THE INVENTION

In the structure of existing light bracket, the fluorescent light is fixed in a piece of arc sheet metal or both sides of the fluorescent light are fixed with a piece of sheet metal. The product made in this arrangement only improves the luminance to a limited extent against the bare fluorescent light.

### SUMMARY OF THE INVENTION

The purpose of the invention is to provide a simply structured support for the fluorescent light with better effect in luminance and energy-saving compared to the existing support for the fluorescent light with little improvement in luminance.

To achieve this purpose, the invention provides a support for the fluorescent light consisting of a reflector (2), a house (1), a frame for fixing the reflector (3), fluorescent lights (4), transparent plate (5), and waterproof washer (6). The reflector in the support consists of a reflector plate with multi mirror surfaces in the shape of open pentagonal prism [symbol] or open heptagonal prism [symbol] The reflector (2) may be made as of single or multiple units, fixed on the frame (3). The transparent plate (5) is attached to the house (1) directly and sealed with the waterproof washer (6) between the transparent plate (5) and the house (1).

When used for road lighting, the whole light is borne by the tubular cantilever (8), which is attached to the light by the cannulation nut (7).

The technical scheme of the present invention has the following advantage: With the fluorescent light placed in a specific position in front of the reflector, when the beam emitted from the midline of the luminous tube beats down on the center of a surface of the reflector, it will be reflected to the right ahead of the support for the fluorescent light. When the incident light beats down on the edge of the surface, the reflected light will have an inclination against the right ahead. Within the inclination, the reflected light flux from the reflector will be equivalent to that of a single fluorescent light. Within a certain inclination, the reflected light flux from the reflector on right back of the fluorescent light will be equivalent to that of half of that of a fluorescent light. Thus the flux of the whole support for the fluorescent light will be: n(m+½)L (wherein n is the number of reflector units and m is the number of reflector surfaces, and L is flux of a single fluorescent light).

### BRIEF DESCRIPTION OF THE DRAWINGS

FIG. 1 is schematic diagram of the support for the fluorescent light of the present invention.

FIG. 2 is functional schematic diagram of the reflector.

FIG. 3 is structural schematic diagram of the reflector with 5 surfaces.

FIG. 4 is structural schematic diagram of the reflector with 7 surfaces.

FIG. 5 is schematic diagram for road lighting.

### DETAILED DESCRIPTION OF THE PREFERRED EMBODIMENTS

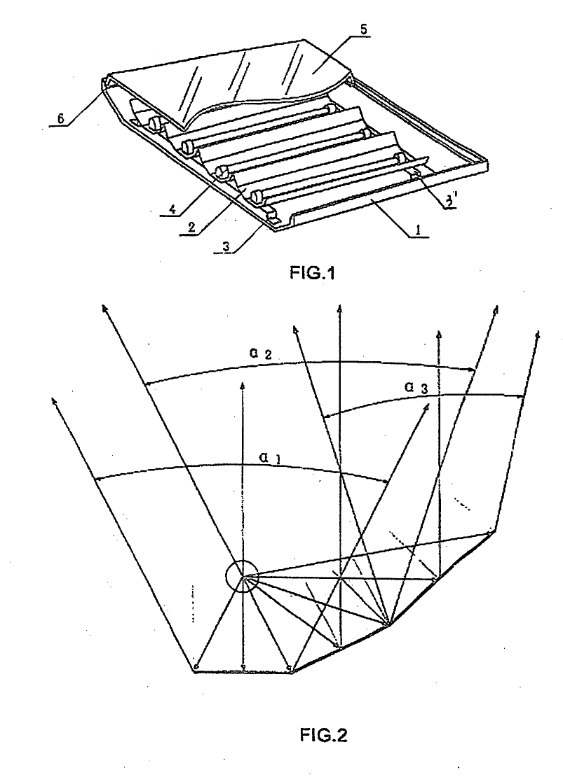

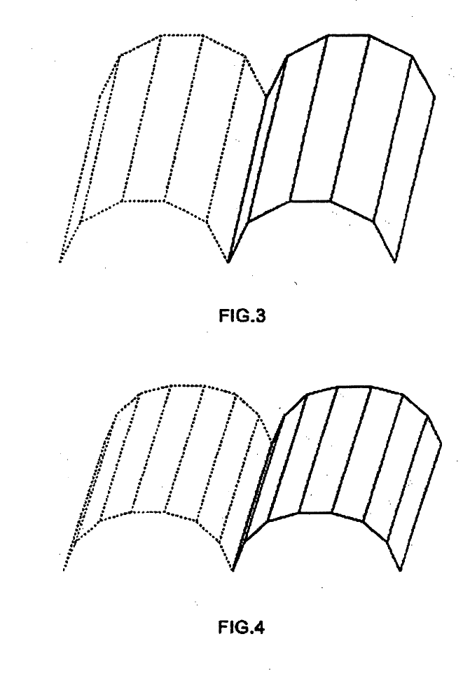

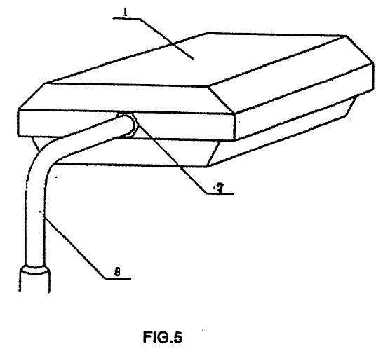

Shown in FIG. 1 is the connecting structure in general of a support for the fluorescent light. The support consists of a house (1) with 2 frames for fixing the reflector (3, 3′) in it. The reflector with 5 or 7 surfaces (2) is arranged and fixed on the frame (3, 3′). The transparent plate (5) is attached directly to the house (1) and sealed with the waterproof washer (6) between the transparent plate (5) and the house (1). The luminous tube bases on both ends of the luminous tube (4) are pressed hard against the reflector (2) and fixed on the support, securing the relative position between luminous tube (4) and reflector (2).

In another embodiment of the invention, the support for the fluorescent light is used for road lighting, there is one opening at one end of the house (1). The whole light is borne by the tubular cantilever (8), which is attached to the support for the fluorescent light by the cannulation nut (7).

Shown as FIG. 2, when the beam emitted from the midline of the luminous tube beats down on the center a surface of the reflector, it will be reflected to the right ahead of the support for the fluorescent light. When the incident light beats down on the edge of the surface, the reflected light will have an inclination against the right ahead. Within the inclination, the reflected light flux from the reflector will be equivalent to that of a single fluorescent light. Within a certain inclination, the reflected light flux from the reflector on right back of the fluorescent light will be equivalent to that of half of that of a fluorescent light. Thus the flux of the whole support for the fluorescent light will be: n(m+½)L, wherein n is the number of reflector units, m is the number of reflector surfaces, L is flux of a single fluorescent light).

Besides, the reflector is fixed in the support directly through the frame for fixing the reflector, providing effect of fixation and heat radiation. The luminous tube bases are pressed hard against the reflector and fixed on the support, securing the relative position between luminous tube and reflector.

1. A support for the fluorescent light including a reflector (2), a frame for fixing the reflector (3), a house (1), fluorescent lamps (4), a transparent plate (5), and a waterproof washer (6) is characterized by that the reflector consists of a reflector plate with multi mirror surfaces in the shape of open pentagonal prism [symbol] or open heptagonal prism [symbol] with the fluorescent light placed in a specific position in front of the reflector, when the beam emitted from the midline of the luminous tube beats down on the center of a surface of the reflector, it will be reflected to the right ahead of the. When the incident light beats down on the edge of the surface, the reflected light will have an inclination against the right ahead. Within the inclination, the reflected light flux from the reflector will be equivalent to that of a single fluorescent light. Within a certain inclination, the reflected light flux from the reflector on right back of the fluorescent light will be equivalent to that of half of that of a fluorescent light. Thus the flux of the whole support for the fluorescent light will be: n(m+½)L (wherein n is the number of reflector units and m is the number of reflector surfaces, and L is flux of a single fluorescent light).

2. A support for the fluorescent light according to claim 1, characterized by that the reflector (2) is made as of single or multiple units, fixed on the frame (3). The reflector is fixed in the house directly through the frame for fixing the reflector (3), providing effect of fixation and heat radiation.

3. A support for the fluorescent light according to claim 1, characterized by that the transparent plate (5) is attached to the house (1) directly and sealed with the waterproof washer (6) between them.

4. A support for the fluorescent light according to claim 1, characterized by that when used for road lighting, the whole light is borne by the tubular cantilever (8), which is attached to the support for the fluorescent light by the cannulation nut (7).
